(19) United States
(12) Patent Application Publication
(10) Pub. No.: US 2005/0232207 A1
(43) Pub. Date: Oct. 20, 2005

(54) Wideband intercom and secure packet radio (WISPR)

(75) Inventors: Panagiotis Antoniadis, Vrilissia (GR); Stergios Topis, Athens (GR); Nikolaos Saitis, Glyfada (GR); Stylianos Potirakis, Pkefi (GR); Aristidis Theodorou, Xalandri (GR); Angelos Avrasoglou, Xalandri (GR); Evangelia Athanasouli, Neo Psyxiko (GR); Georgios Tzanetos, Peania (GR)

Correspondence Address: KING & SPALDING LLP, 191 PEACHTREE STREET, N.E., 45TH FLOOR, ATLANTA, GA, 30303-1763, US

(73) Assignees: INTRACOM S.A., ATHENS (GR); HELLENIC TELECOMMUNICATIONS & ELECTRONICS INDUSTRY, ATHENS (GR)

(21) Appl. No.: 10/893,133

(22) Filed: Jul. 16, 2004

(30) Foreign Application Priority Data
Apr. 16, 2004 (GR) 20041000133

(51) Int. Cl. H04Q 7/24

(52) U.S. Cl. 370/338

(57) ABSTRACT

A Wideband Intercom and Secure Packet Radio (WISPR) system includes a state-of-the-art digital, fully programmable communication system that provides internal and external communication to the operators of any type of vehicle. The WISPR system includes a dedicated secure radio with anti-jamming capabilities in order to support a Wireless Local Area Network (WLAN) and is able to provide voice and data communication over radios, analog wires and data/voice over field telephones and tank telephones. The system supports a variety of user specified operational requirements (e.g. hierarchy plans, closed group conference, wired or wireless remote radio control, tactical data reception, independent listen/talk functions) and has the capacity for dynamic adaptation to field requirements and the potential for expansion in order to fulfill the future needs of the Armed Forces. The WISPR system configuration is adaptable according to the type of platform and the particular operational requirements for a specific application.

### TECHNICAL FIELD

The present invention relates to the field of modern communication systems and networks, and in particular to intercom and radio communications systems. It specifically concerns a state-of-the-art, digital, fully programmable communication system, with a dedicated radio unit that provides internal and external communication to the operators of platforms, such as vehicles, shelters, vessels, etc. The system is able to provide voice and data communication over radios, analog wires, field telephones and supports a Wireless Local Area Network (WLAN). It also has the capacity for dynamic adaptation to field requirements and the potential for expansion in order to fulfill the future needs of the Armed Forces.

### BACKGROUND OF THE INVENTION

Most of today's intercom systems are built to support simple audio communication among crewmembers of an operations platform. The operations supported by the intercom systems include simple information exchange, command orders, or communication with external support or command forces through the use of platform radios. However, modern communication requirements are not restrained to just simple intercommunication operations.

Information, high speed data, video and image exchange with external support forces compose vital functions, that enhance the field capabilities and survivability of the crewmembers and installation platforms. Additionally, communication systems are usually composed of several independent subsystems dedicated to a specific type of communication. As a result of this, interoperability is a key issue that allows these subsystems to work with each other. This leads to the development of new open architectures, which integrate different state of the art technologies and services into a single multifunctional system.

The majority of military intercommunication systems follow an architectural concept based on either ring or star topologies 100a, 100b as depicted in FIGS. 1a and 1b respectively. In a star topology 100a of FIG. 1a, a central distribution unit 101, which usually includes most of the electronic circuits, is assigned with the arbitration and control of all connected system units 120a-f. The same central distribution unit 101 provides for audio and where applicable data distribution and switching to all system units 120 via separate connections. The major disadvantage of the star topology 100a is the existence of a single point of control and switching, which constitutes a single point of failure. A possible failure or destruction of the central distribution unit 101 will result in a complete system shut down.

In a ring topology 100b of FIG. 1b, a central control unit 102 performs the same tasks as the equivalent star topology 100a with the central distribution unit 101, however, the system unit connectivity follows a different approach. All system units 120a-e are connected in series, creating a closed communication ring based on information retransmission from one unit to another. Ring topology 100b encompasses the same drawbacks as the star topology 100a, having no decentralization mechanism in terms of system arbitration and control.

Accordingly, there is a need in the art for a new approach which utilizes the best aspects from both the “Bus” and “Star” topologies and that introduces an innovative decentralization mechanism having no single point of failure, thus increasing system reliability and survivability. There is also a need in the art for a system that provides simultaneous voice, data and control services with dynamic adaptation to modern battlefield requirements.

### SUMMARY OF THE INVENTION

The term “WISPR” shall mean Wideband Intercom and Secure Packet Radio. The invention can include a WISPR system that can comprise a state-of-the-art digital, fully programmable communication system that provides internal and external communication to the operators of several types of platforms. Platforms can include, but are not limited to, vehicles, shelters, vessels, etc. The WISPR system can include a dedicated and secure radio with anti-jamming capabilities in order to support a Wireless Local Area Network (WLAN). The WISPR system can provide voice and data communication over a number of external devices such as radios, analog wires, field telephones and tank telephones.

The WISPR system architecture can combine “Bus” and “Star” topologies that introduces an innovative dynamical assignment mechanism for central control and a dynamically distributed mechanism for arbitration and switching operations. Thus, the central control mechanism, in contrast with existing systems, may not be permanently bound to a fixed dedicated hardware unit. System hardware (HW) can follow a BUS-like architecture whereas system software (SW) can follow a STAR-like architecture.

In the “Bus Topology” followed by the WISPR system HW, several units can be interconnected in a bus representing the infrastructure that supports the intercommunication operations. The WISPR system can equipped with an additional redundant bus for improved reliability, which can be automatically used in case of main system bus failure. Additionally, the redundant bus can be used to improve data transmission bandwidth in both directions in case of increased communication requirements and/or system configuration. This architecture can offer a high degree of reliability, upgradeability (independent of communication type services) as well as operational availability. In parallel, the WISPR system can support, increased system bandwidth, easier unit installation at any position of the system bus, as well as system expandability without intervention in the existing system hardware and software setup or any other kind of modifications.

The WISPR system SW can feature a dynamically appointed (among user terminals) central control unit, thus eliminating or reducing the possibility of a complete system failure. This can be accomplished through a combination of techniques, allowing for reuse of system resources, thus resulting in exceptional system performance, even in case of unit malfunction or even destruction. All units can be continuously monitored and when a faulty unit is detected, this unit can be isolated and an alarm is given. In this case, if the faulty unit is the commander unit, the system can automatically reassign the commander's privileges to another unit. Also due to this distributed architecture, all units can be installed in any sequence on the bus. Additionally, system architecture can provide for automatic unit identification during installation regardless of unit functionality, enabling the reconfiguration of the overall system synthesis. The same applies during removal of a system unit.

The scalable architecture of the system can support connections to Field Telephones & PSTN lines (Public Telephone Network) for voice and data communication, as well as interfaces to existing LAN infrastructures in order to support data services. The WISPR system can offer system level interoperability through standardized interfaces (i.e. Ethernet, RS-232) and can be used as an autonomous communications backbone.

The system can introduce a new operational philosophy where all user terminals (such as Crew Control Units or CCUs) are identical and interchangeable. The distinction among user terminals in terms of access rights and operations can follow the field chain of command (e.g. commander, crew) and can be dynamically programmable.

The decentralized approach followed in the WISPR system, can allow for a CCU to be dynamically appointed among the user terminals in accordance with a given operational and sequence profile. The WISPR user terminals (CCU) can be identical and interchangeable, as mentioned, incorporating all necessary circuitry and software for control, program and arbitration. Based on dynamic privilege assignment capability and given the authorization, any of the user terminals can realize both control and arbitration operations for a complete WISPR System, performing as the equivalent central distribution unit of a star or a ring topology.

The system SW can follow a dynamically centralized approach in order to deliver the desired Quality-of-Service (QoS) for voice and data communication. The user terminal (CCU) operating in commander mode can be automatically assigned with additional responsibilities and abilities, compared to the other user terminals (crew units). Furthermore, based on system re-programmable capabilities, the commander user terminal can be assigned with the management control of the overall WISPR system.

The WISPR system can also provide enhanced audio and data services through the use of service-dedicated units, all connected on the same data bus. The WISPR system can have no limitation in terms of system configuration or unit combinations, thus enabling the setup of a communications system to fulfill all present and future operational needs of the Armed Forces. This means that the system can support integrated configuration management and the system parameters can be set without the usage of external devices. Audio and data switching can be performed locally on every user terminal, thus enabling the implementation of a variety of audio and data services, according to the operational profile of each user. The latter can be accomplished through the use of a redundant multi-drop bus, which can create a sharing path for voice and data exchange among users.

The voice and data services of the system can provide the users with maximum flexibility in tactical communication environments. These services can be assigned in predefined or programmable keys, aiming to increase flexibility and minimize their activation time. The operations of separate “listening” and “talking” can be configured dynamically according to the system topology. The WISPR system can operate in full duplex mode, allowing every crewmember to enable “talk” and “listen” functions at the same time to as many connections as available by the system. Dedicated keys on the CCU keyboard can select distinct listen and talk functions.

All special services can be fully programmable by the platform commander, who can define the communication modes among users (closed intercom groups, as well as the hierarchy priority plan). Additional services offered by the system can be organized in a Selection Menu to which the user has immediate access. The WISPR system can provide for an extended number of unique services such as:
Short message transfers between users and over external communication interfaces;
Message status indication;
Dynamic system unit labeling;
Dynamic loudspeaker unit position identification and selection of listening channel from loudspeaker independently of unit listening operational mode;
Selective call;
Advanced routing capabilities through different communication media;
VIDEO transfer;
High-speed wireless communication with fixed and mobile users;
Hierarchy priority plan;
Complete protocol implementation and remote control of platform radios for operational parameters modification, data and voice transfer; and
Radio mode operation indication at users displays (radio on—off—remote controlled).

The distinction among user terminals in terms of access rights and operations, can follow the field chain of command (e.g. commander, crew) and can be dynamically programmable, providing selective call capability inside the platform according to the hierarchy plan. The WISPR system can provide the capability of generation of dynamically programmed closed intercom groups, where the commander can program and generate closed communication groups between users of the same system according to a certain application. The commander can generate several different closed groups according to specific application requirements. A crewmember can belong to more than one closed group at the same time. The CCU via emergency key can provide for the commander the capability to broadcast to all crewmembers regardless of any ongoing conversation. The emergency call can comprise a one-way call, which overrides the communication status of the system. The same service can provide for each user the capability to establish priority connection with the commander. The WISPR system can provide for advanced alarm data collection and distribution capabilities through audiovisual messages to all internal system users, as well as to external users via all available communication interfaces. All system units can be equipped with dedicated LED indicators for power, alarm signals, network status and commander call.

The WISPR system features Dynamic Noise Reduction (DNR), which can be performed in every single CCU by a digital signal processor and can be applied directly to the noise source. The sophisticated DNR algorithm can be adaptable to the noise profiles of various platforms. The system can also provide for exceptional performance in terms of audio intelligibility, even when used with headsets not equipped with Active Noise Reduction (ANR) circuitry. Furthermore, the WISPR denoising mechanism is usually not dependent on a reference noise acquisition microphone.

The WISPR system extensive interfacing capabilities can provide for a variety of connections and interfaces, such as:
Analog and digital voice services;
Data transmission through serial protocols;
Connection to LAN (Ethernet);
Connection to radio units (e.g. HF, VHF, UHF radios);
Connection to PSTN networks;
Connection to Field Telephones and Tank Telephones;
Connection to Terminals, Radars, Battle Management Systems etc.

One innovative feature introduced by the WISPR system is the capability of establishing a short range WLAN, based on spread spectrum technology. The WLAN infrastructure can extend the system bus to a wireless one, thus adding to the capabilities of the WISPR system with high-speed external communications and establishing it in a manner, which can allow for fast deployment of a communications network in any environment. The link and the access to the WLAN can be established and serviced by a dedicated transmitter and a WLAN control unit (Wireless LAN Control Unit—WLCU) respectively, which is assigned with the control and monitoring of the WLAN. The output (transmission) power of the WLCU can be adjusted by the system.

The WLCU can offer the following operations:
Independent packet voice and data communication in fixed and variable data rates, active even when “Radio Silence” to the conventional external communication systems of the platform is applied;
SMS exchange between CCU's of different platforms or from and to external users to system platforms;
Anti-jamming techniques, data encryption and high degree of transmission undetectability;
Generation of closed groups at different system platforms and/or platforms and support units;
Full remote control and access of conventional radios installed in other vehicles including unmanned vehicles;
Remote control capabilities of conventional radios from mobile users of a specific platform;
Video teleconference applications and real time and still image transfer capability;
Support of mobile users (equipped with mobile control units) for voice and data communication, video transfer and wireless control of the vehicle (platform) radios; and
Transmission power level control;
All of these supported operations can be accessed/utilized by both local WISPR system and remote users. The WISPR system can provide for remote users the capability of utilizing all available resources in the form of services, as well as serving as a gateway in order to route their requests to other communication systems through its interfaces. This capability adds to the WISPR system another operational mode in addition to that of an autonomous communication system. It can enable the WISPR system to operate as an intermediate communication node for other systems.

Furthermore, the WISPR system can offer full interoperability with Battle Management Systems (BMS), thus providing a tactical advantage in maintaining the BMS in full operation among vehicles via the WLAN. The communication among BMS can remain operational, even when “Radio Silence” is applied to the conventional external communication systems of the platform, due to the high degree of undetectability that the system provides. Furthermore, the WISPR system can enhance the operational capabilities of any BMS, through the usage of the WLAN configuration that supports the exchange of large amounts of information among platforms in only a fraction of the time compared to the time required by conventional radios. As a result of this, BMS users can maintain battlefield situation awareness in near real time.

In addition, the WISPR system can provide the following detailed mechanical and operational features:
Easy installation and system expandability without intervention in the existing system hardware and software setup;
Ergonomically designed units;
Normal system operation even under adverse environmental conditions of temperature, humidity, shock, vibration and mechanical strain according to MIL-STD 810;
Anti-vibrating protection of all installed devices within the protected vehicle (platform);
Electromagnetic Interference (EMI)/Electromagnetic Compatibility (EMC) requirements according to MIL-STD 461 and MIL-STD 462
High reliability and maintainability

### BRIEF DESCRIPTION OF THE DRAWINGS

FIG. 1a illustrates a conventional star topology for a communications system.

FIG. 1b illustrates a conventional ring topology for a communications system.

FIG. 1c illustrates a conceptual diagram of the WISPR system according to one exemplary embodiment of the invention.

FIG. 2 illustrates one typical configuration of the WISPR system that describes most of the system units and how they are connected according to one exemplary embodiment of the invention.

FIG. 3 illustrates a wireless LAN application of the invention that includes independent WISPR system LAN communications according to one exemplary embodiment.

FIG. 4 illustrates a wireless LAN application of the invention that includes communication with a mobile unit according to one exemplary embodiment.

FIG. 5 illustrates a wireless LAN application of the invention that includes a high speed information relay according to one exemplary embodiment.

FIG. 6 illustrates a wireless LAN application of the invention that includes wireless remote radio control according to one exemplary embodiment.

### DETAILED DESCRIPTION OF EXEMPLARY EMBODIMENTS

The WISPR system can offer a complete telecommunication solution among users, incorporating voice and data services. The system configuration can be adaptable according to the type of platform to be equipped with and the particular operational requirements for the specific application.

Referring now to the drawings, in which like numerals represent like elements throughout the several figures, aspects of the present invention and the preferred operating environment will be described.

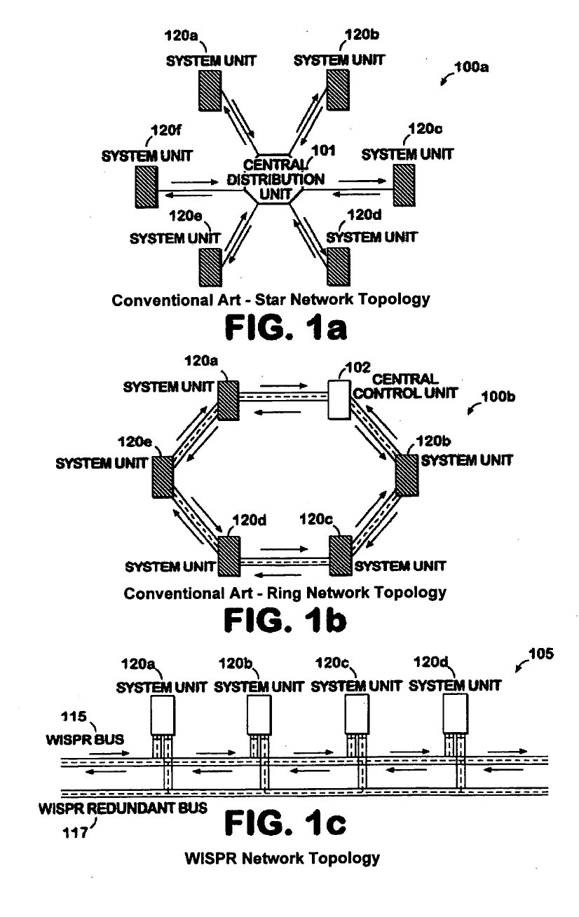

Referring to FIG. 1c, this figure illustrates a conceptual diagram of the WISPR system's network topology according to one exemplary embodiment of the invention. This figure illustrates a WISPR system 105 that has a first bus 115 and a second redundant bus 117. With this second redundant bus 117, the WISPR system does not have a single point of failure, and therefore, its reliability and survivability are increased.

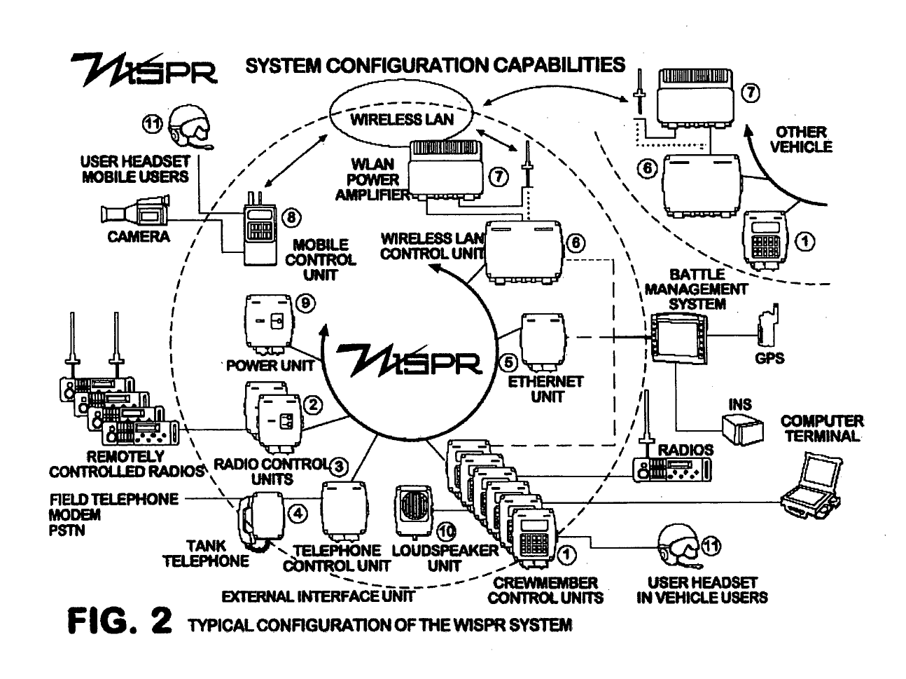

Referring now to FIG. 2, this figure illustrates one typical configuration of the WISPR system 105 that describes most of the system units and how they are connected according to one exemplary embodiment of the invention. According to this exemplary embodiment, the WISPR system 105 can comprise the following operational units:
Commander (Crewmember) Control Unit (CCU) (1);
Radio Control Unit (RCU) (2);
Telephone Control Unit (TCU) (3);
External Interface Unit (EIU) (4);
Ethernet Unit (ETU) (5);
Wireless LAN Control Unit (WLCU) (6);
WLAN Power Amplifier (WPA) (7);
Mobile Control Unit (MCU) (8);
Power Unit (PWRU) (9);
Loudspeaker Unit (LSU) (10);
User Headsets (HDSET) (11);

According to this exemplary embodiment, the Commander Control Unit (CCU) (1) can creates logical communication links among users and it can host the input/output voice devices. The CCU 1 can support two operating modes, “Commander” and “Crew”. Only one CCU 1 per WISPR system 105 can typically operate in “Commander” mode. This selection of “Commander” mode constitutes a dynamic process and can be executed at any time. The CCU 1 in “Commander” mode can provide for the user (i.e. the commander) additional capabilities related to system administration, activation and deactivation of system services and access control to services. Such services can include, but are not limited to, access to platform radios, PSTN lines, Ethernet network, etc.

The CCU 1 in “Crew” mode can provide the user with complete communication services. A dedicated powerful digital signal processor utilizing a sophisticated noise reduction algorithm, can perform Dynamic Noise Reduction (DNR) in the CCU 1 and provides an adaptive noise level digital Voice Operated Switch (VOX) and Automatic Gain Control (AGC). The de-noising process can be attained at the input of the audio signal and it can be headset independent.

Every user terminal (CCU 1) can be equipped with an advanced and specially designed Human-Machine Interface (HMI) featuring a visual display, an illuminated command alphanumeric keyboard indicating communication status according to color code. The visual screen (Vacuum Fluorescent Display, VFD) can be used for displaying messages and selections of services. The display brightness can be adjustable and can be set to different levels. Dedicated keys can be linked to voice services, resulting in quick access and fast activation of the most common communication operations. The CCU 1 can support a variety of external peripherals through dedicated connections, such as to, but not limited to, loudspeakers, headsets, radios, etc. Additionally the CCU 1 can be equipped with a serial interface to support a PC connection. The CCU can also be connected to the system bus.

The Radio Control Unit (RCU) (2) provides for full access and remote control of the radios attached to the system, thus eliminating the need for physical access to the radios. Each RCU unit 2 is capable of controlling two radios. The communication access to the radios is controlled and enabled by the commander CCU 1. The RCU 2 is a programmable and fully microprocessor controlled unit. The RCU unit 2 can be connected to the system bus and it can provide a connection to a Personal Computer (PC). Each RCU 2 can be equipped with two LEDs supporting two operational states namely: a) “Operational” (PWR LED on) which indicates that the unit is on; and b) “Connection” (NET LED on) which indicates connection with the system bus.

The Telephone Control Unit (TCU) (3) can provide for a tank telephone 4, a field telephone and two PSTN connections. The TCU 3 can allow the WISPR system 105 to be connected to external lines in order to support voice and data transfer, as well as, connections to a public telephone network (PSTN). When the TCU 3 is connected to the WISPR system 105, authorized users are able to establish calls from/to a PSTN network through the use of the keyboard of the CCU 1. Each TCU 3 can provide the WISPR system 105 with the flexibility to support various ways of data transfer, which are defined according to the operational needs for tactical communications. Field telephone users can be allowed to use platform radios, if they enter a preprogrammed access code in the field telephone panel. The TCU 3 can comprise a programmable and fully microprocessor controlled unit, connected to the system bus. The commander CCU 1 can activate and control each TCU 3 automatically.

The External Interface Unit (EIU) (4) can be connected to the TCU 3 and can be installed outside the vehicle (in the relevant protective case), providing easy access to the telephone network. Furthermore, the EIU 4 can provide wired voice communication with the interior of the vehicle and consequently with other equipment attached to the WISPR system 105 such as, but not limited to radio equipment. The EIU 4 can provide the interfaces to a field telephone, two PSTN lines, a user handset and a headset connection. The EIU 4 can provide an internal call LED indicator, volume control buttons and intercom/radio communication selection switch.

The Ethernet Unit (ETU) (5) can support a 10/100Base-T auto-negotiated Ethernet connection. The ETU 5 can allow for the WISPR system 105 to be connected to external LANs in order to support high-speed data transfer. The ETU 5 can also support a serial PC connection. The ETU 5 can comprise a programmable and fully microprocessor controlled unit, connected to the system bus. The commander CCU 1 can activate and control the ETU 5 automatically.

The Wireless LAN Control Unit (WLCU) (6) can comprise the dedicated radio unit of the WISPR system 105. The WLCU 6 can be used as a gateway to interconnect independent networks in environments where a high-speed telecommunications infrastructure is required. The operation of the networks can be self-contained and self-governed in order not to affect the communication connections. The commander CCU 1 can activate and control the WLCU 6 automatically, granting access to the WLAN and connecting neighboring WISPR systems 105′. The communication link can support voice communication and has the capability to recognize automatically the WLAN infrastructure. Furthermore WLCU 6 can support bi-directional data exchange among units in a WLAN. This service can be supported either between different WISPR systems 105 such as on vehicles or between a WISPR system 105 on a vehicle and a MCU mobile user such as an out of-vehicle crew member.

The WLCU 6 can support the exchange of SMS messages between CCUs 1 of different platforms. The Wireless Network can service this application transparently. The recipient of the SMS message can be a number of specific CCUs 1 of the destination WISPR system 105. The system is capable of setting up a wireless communication group between WLAN equipped WISPR platforms 105 or capable of establishing a point-to-point connection with another WISPR system 105 via the WLAN interface.

Additionally, in the event of failure of the VHF Radios of a WLAN equipped platform, the WISPR system 105 can provide for remote access and control of a VHF Radio located on another WLAN equipped platform, thus re-establishing long distance communications.

Each WLAN can support emergency one way outgoing calls from the Commander CCU 1. The emergency call is typically received by all WLAN equipped platforms participating in the Local Wireless Network (broadcast transmission).

The WLCU 6 can comprise a programmable and fully microprocessor controlled unit that is connected to the system bus. The WLCU can be equipped with an Ethernet port providing connection to external LANs and a serial RS 232 interface for PC connection. Indication LEDs can notify about power errors and network connection.

The WLAN Power Amplifier (WPA) (7) can provide extended range of communication for the WLCU 6. This bi-directional RF power amplifier can comprise two main amplification parts. The amplification part can be responsible for transmission coupling and guiding the signal to the antenna. Meanwhile, the receiver amplification part can be responsible for guiding the received signal to the WLCU 6 demodulation and digital processing circuits. The WPA 7 can incorporate EMI and Voltage Standing Wave Ratio (VSWR) protection. The WPA 7 can have two external Subminature A (SMA) connectors for connection with the antennas and a SMA connector for radio frequency (RF) connection with the WLCU 6. Indication LEDs can notify about power errors and high VSWR.

The Mobile Control Unit (MCU) (8) can comprise the WISPR system mobile communication unit that is powered by a rechargeable battery pack. It can provide for the capability of wireless communication between mobile and stationary WISPR system users. The MCU 8 can support bi-directional voice and data transfer, while it can keep all the advantages of an ergonomically designed hand held device. The user of an MCU 8 can access remotely and control the conventional radios (e.g. HF, VHF, UHF radios) that are attached to a Wireless LAN equipped platform. The MCU 8 can be crash and vibration proof and water and dust proof. Each MCU 8 can be equipped with a display, a keypad and a flexible external antenna.

The Power Unit (PWRU) (9) can comprise a power protection and filtering unit for the WISPR system 105, which is connected with the available power supply sockets of the vehicle and the bus on which all the system units are interconnected providing power to all attached WISPR units. The PWRU 9 can incorporate all necessary protection circuitry against input voltage variations, spikes, short circuits etc. The power LED of the PWRU 9 shows the unit operational condition. It can have two states indicating:
a) normal operation (yellow) and
b) failure of power consumption (off)

The Loudspeaker Unit (LSU) (10) can comprise an active loudspeaker unit. Each LSU 10 can also include a power supply, an audio amplifier and a volume control circuit. The LSU 10 can accept the analog (electrical) voice signal from CCU 1 and reproduce it acoustically. The LSU 10 can incorporate a special Power Supply Unit.

The User Headset (HDSET) (11) can comprise a standard CVC helmet without Active Noise Reduction (ANR) and is connected to the audio connector of the CCU 1. Furthermore the WISPR system 105 can be connected to any standard CVC type helmet or headset, subject to specific requirements. The WISPR system 105 also supports headsets equipped with ANR circuitry and electret type microphones, providing power through the audio connector. However, it is noted that ANR type headsets are not solely required for the WISPR system 105, since de-noising is implemented internally in the CCU 1.

External connectors in all the above described WISPR units typically meet military standards. All of the devices are intended to be interconnected alternatively, fulfilling in this way an improved reliability, environmental resistance and conforming to all the necessary requirements for EMI/EMC.

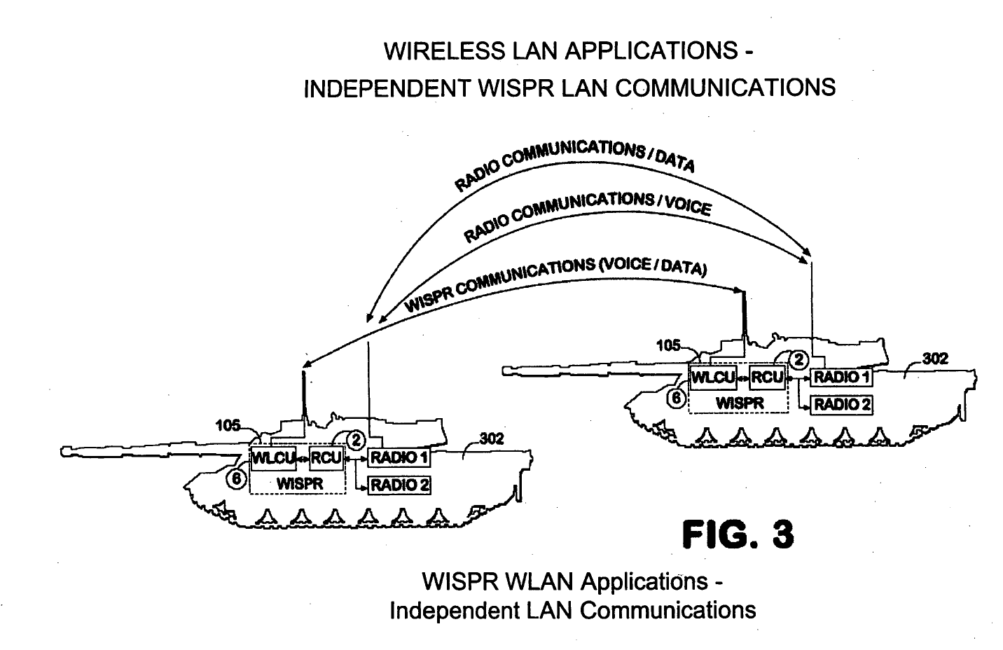

Referring now to FIG. 3, this figure illustrates wireless communications between separate WISPR installation platforms 105 such as battle tanks 302 according to one exemplary embodiment of the invention. The communications can comprise voice and data. These communications can be exchanged by either using the combat net radios of the vehicle 302 or by using the dedicated radio unit (WLCU) 6 of the WISPR system 105. This WLCU 6 offers link security such as anti-jamming capability using spread spectrum technology, information security, very low detection probability and IP based communications.

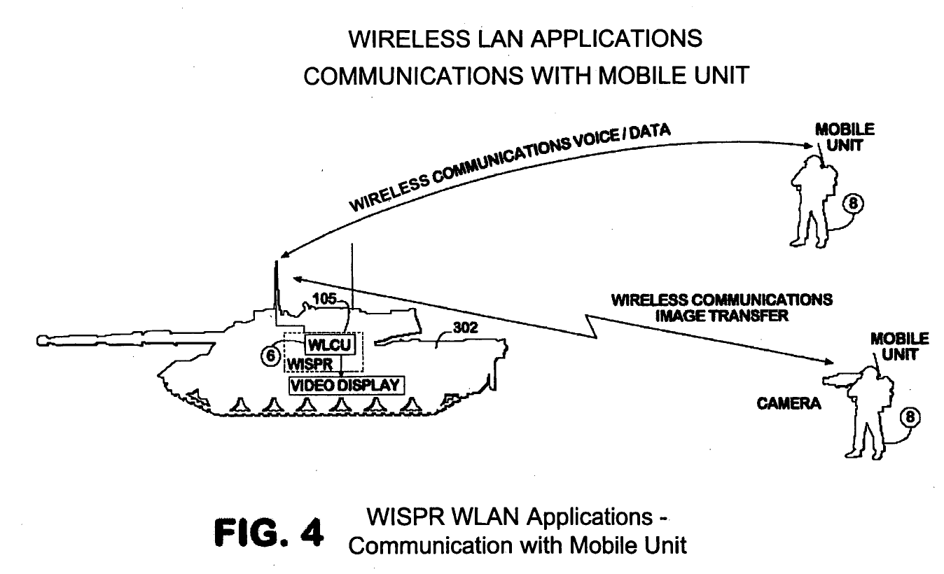

Referring now to FIG. 4, this figure illustrates communication between a WISPR installation platform 105 such as a battle tank 302 and mobile units 8 that use the dedicated WISPR radios according to one exemplary embodiment of the invention. With this capability, a mobile user can communicate securely and undetected with any WISPR installation platform 105 in order to send high rate data such as video image transfers. In voice or data mode, the mobile user can perform broadcast, multicast or selective call.

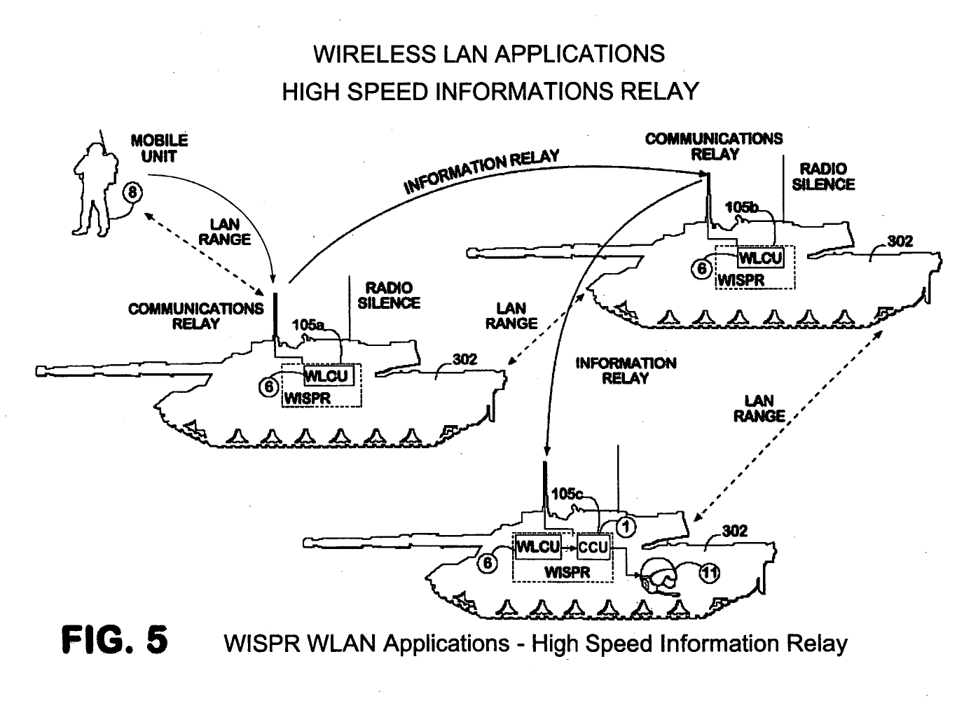

Referring now to FIG. 5, this figure illustrates high-speed relay information functionality according to one exemplary embodiment of the invention. When a first and second WISPR installation platform 105a, 105c of mobile users are not in the range that the WISPR WLAN supports, then they have the capability to communicate (using voice or data or both) with each other using a third WISPR system 105b as a radio relay station. The third WISPR system 105b can provide routing and the necessary QoS in order to support voice or data (or both) types of communication.

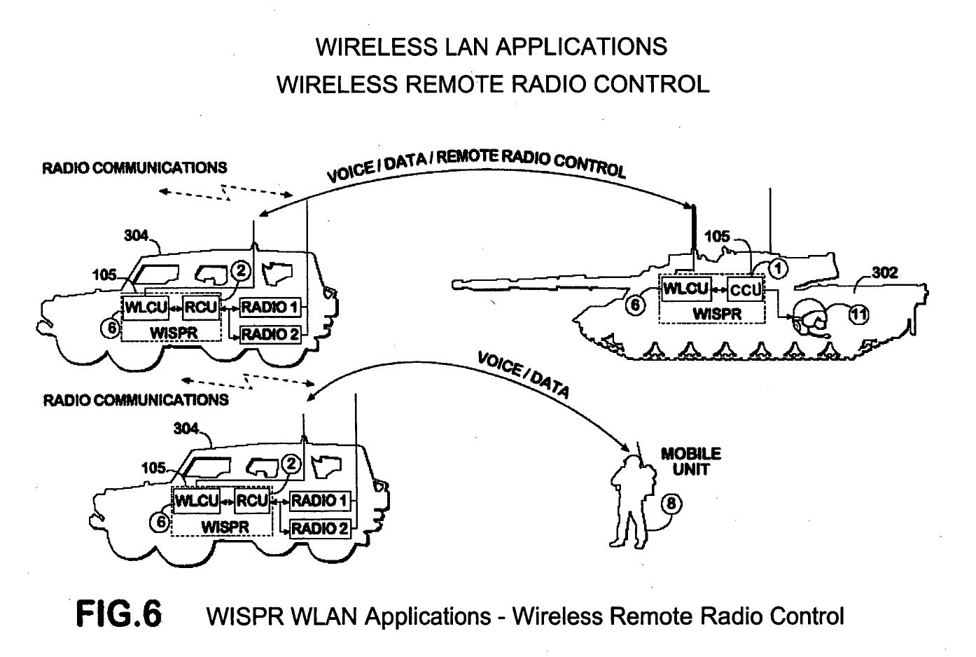

Referring now to FIG. 6, this figure illustrates a wireless remote radio control feature according to one exemplary embodiment of the invention. The WISPR system 105 using its own dedicated radios is capable of full remote control of combat net radios that are installed in other platforms (manned or unmanned) 302, 304. The wireless remote radio control can be performed either through the WLCU 6 or through the mobile unit 8.

TABLE 1
ABBREVIATIONS

| | |
|---|---|
| AGC | Automatic Gain Control |
| ANR | Active Noise Reduction |
| BMS | Battle Management System |
| CCU | Crewmember (Commander) Control Unit |
| CVC | Combat Vehicle Crew |
| DNR | Dynamic Noise Reduction |
| EIU | External Interface Unit |
| EMC | Electromagnetic Compatibility |
| EMI | Electromagnetic Interference |
| ETU | Ethernet Unit |
| HDSET | Headset |
| HMI | Human Machine Interface |
| HW | Hardware |
| LAN | Local Area Network |
| LED | Light Emitting Diode |
| LPD | Low Probability of Detection |
| LSU | Loudspeaker Unit |
| MCU | Mobile Control Unit |
| QoS | Quality of Service |
| PR4G | Post Radio 4 Generation |
| PSTN | Public Switched Telephone Network |
| PWRU | Power Unit |
| RCU | Radio Control Unit |
| RF | Radio Frequency |
| SMA | SubMiniature A |
| SW | Software |
| TCU | Telephone Control Unit |
| VFD | Vacuum Fluorescent Display |
| VOX | Voice Operated Switch |
| VSWR | Voltage Standing Wave Ratio |
| WISPR | Wideband Intercom Secure Packet Radio |
| WLAN | Wireless Local Area Network |
| WLCU | Wireless LAN Control Unit |
| WPA | WLAN Power Amplifier |

The WISPR system 105 can be used for the internal and external communications of any kind of vehicle or other platforms (e.g. shelters, vessels). The system 105 provides a dedicated radio that includes an external wireless network capable of supporting digital communication secretly and with Low Probability of Detection (LPD) between installation platforms and dedicated portable radios carried by mobile users. The system 105 employs enhanced voice services using advanced noise reduction algorithms. The system 105 provides real time static image transfer, video and high data rate transfer capability. The system 105 also provides wired and wireless remote control of combat net radios. The system 105 provides routing capabilities between all supported interfaces, special operational services, interfaces to combat net radios, PSTN networks, field and tank telephones. The system 105 can interface with any kind of terminal (e.g. computer, radar, Battle Management Systems) through Ethernet, wireless or serial port connections. The system 105 may comprise a bus topology architecture and it can provide power supply filtering.

The WISPR system 105 can provide exclusive point to point (selective call) or point to multi-point (broadcast or multicast) communication connections (voice and high data rate) among installation platforms. The system 105 provides spread-spectrum anti-jamming techniques, data encryption, transmission power level control and high degree of transmission undetectability. The system 105 can also provide extended range of communication to the WLAN with the usage of a dedicated power amplifier. The system 105 supports independent voice and high-speed data communications and video transfer capability, all active even under “combat net radio silence”.

The WISPR system 105 provides dynamic identification of the unit loudspeaker when it is connected and the system 105 provides selection of a listening channel from the loudspeaker independently of unit that is in a listening operational mode. The system 105 provides separate “listening” and “talking” functions dynamically configured according to system topology.

The WISPR system 105 is capable of creating network bridges/routers/communication paths for wired and wireless networks taking the form of a repeater, controller or participant. The WISPR system is capable of full remote control and access of combat net radios installed in other manned and unmanned platforms (wireless remote control) for operational parameters modification, data and voice transfer. The system 105 provides SMS exchange between inside platform system users and/or between different platform users through external communication interfaces.

The WISPR system 105 includes very clear voice services using an adaptive electronic Dynamic Noise Reduction (DNR) algorithm that is adaptable to the noise profiles of various platforms. The DNR can be performed in a single CCU with a digital signal processor. The system DNR algorithm is applied directly to a noise source and is interoperable with any type of headset dependently on reference noise acquisition. The system 105 provides noise level adaptive digital VOX (Voice Operated Switch) and Automatic Gain Control (AGC), both implemented algorithmically by digital signal processing.

The WISPR system 105 supports many special and dynamically field programmable services such as closed groups, short message transfer between users and over radio, hierarchy plan, radio remote control, wireless conference groups with members private data.

The WISPR system 105 provides dedicated operation keys on the CCU keyboard as well as a smart illuminated keyboard indicating communication status according to color code. The CCUs 1 are equipped with dedicated LED indicators for power, alarm signals, network status and commander call operation.

The WISPR system 105 provides the capability of continuous system fault monitoring, faulty unit automatic isolation and alarm indication. The system 105 also provides advanced alarm data collection and distribution capabilities through audiovisual messages to all internal system users as well as to external users via all available communication interfaces.

The WISPR system 105 has an architecture that offers a high degree of reliability, upgradeability (independent of communication type services) as well as operational availability. The system 105 is equipped with additional redundant bus for improved system reliability. The redundant bus is used to improve data transmission bandwidth in both directions in case of increased communication requirements and/or system configuration (e.g. number of CCUs installed at the same platform). The system 105 provides full duplex operational mode and the system 105 can be expanded without intervention in the existing system hardware and software setup.

The WISPR system 105 provides sequence independent unit installation on the bus and the system 105 has an architecture that provides automatic unit identification during installation or unit removal, automatically reconfiguring the overall system synthesis. The Bus topology is used without a static central switching device and uses distributed circuit-switching technology. The system 105 provides automatic reassignment of commander privileges to another unit in case of a primary commander unit failure.

The WISPR system 105 supports emergency key operations providing the system Commander with the capability to broadcast to all crewmembers, regardless of any ongoing conversation. The system 105 supports emergency key operations providing each user with the capability to establish priority connection with the Commander or crew control unit operating in the “Commander” mode.

The WISPR system 105 supports integrated configuration management, dynamic system unit labeling and system parameter setup without the need for external devices.

The WISPR system 105 provides full interoperability with Battle Management Systems (BMS). The WISPR system 105 operates under adverse environmental conditions of temperature, humidity, shock, vibration and mechanical strain according to MIL-STD 810, said system complies with the EMI/EMC requirements according to MIL-STD 461 and MIL-STD 462.

It should be understood that the foregoing relates only to illustrative embodiments of the present invention, and that numerous changes may be made therein without departing from the spirit and scope of the invention as defined by the following claims.

1. A communications system comprising:
a wireless local area network (WLAN), the WLAN comprising a first bus and a second bus, the second bus comprising a redundant bus relative to the first bus; and
a crew control unit coupled to the WLAN operating in one of a first and a second mode, the first mode capable of controlling access for one or more crew control units operating in the second mode to services available on the WLAN, the crew control unit comprising a visual display.

2. The communications system of claim 1, further comprising a plurality of crew control units wherein only one crew control unit operates in the first mode relative to one or more crew control units operating in the second mode.

3. The communications system of claim 2, wherein each crew control unit is identical.

4. The communications system of claim 2, wherein each crew control unit is interchangeable with another crew control unit.

5. The communications system of claim 1, wherein the first mode is dynamically assignable to a first crew control unit so that in case of failure of the first crew control unit, the first mode is assignable to a second crew control unit that was operating in the second mode.

6. The communications system of claim 1, wherein the crew control unit is continuously monitored by the WLAN to detect faults in the crew control unit.

7. The communications system of claim 1, wherein the system provides at least one of point to point and point to multi-point communication connections for crew control units coupled to the WLAN.

8. The communications system of claim 1, wherein the system provides at least one of spread-spectrum anti-jamming techniques, data encryption, transmission, and power level control.

9. The communications system of claim 1, further comprising a headset coupled to the crew control unit.

10. The communications system of claim 1, further comprising a loud speaker unit coupled to the crew control unit.

11. The communications system of claim 1, further comprising a radio coupled to the crew control unit.

12. The communications system of claim 1, further comprising a battle management system coupled to the crew control unit.

13. The communications system of claim 1, further comprising a computer terminal coupled to the crew control unit.

14. A method for providing a reliable communications system, comprising:
providing a wireless local area network (WLAN);
coupling a first and a second communication unit to the WLAN;
assigning a mode to the first communication unit for controlling access to the WLAN; and
assigning the mode to the second communication unit when the first communication unit fails.

15. The method of claim 14, further comprising continuously monitoring a status of the first and second communication units.

16. The method of claim 15, further comprising triggering an alarm if a communication unit fails.

17. A method for providing reliable communications in a military platform, comprising:
providing a wireless local area network (WLAN) in the military platform;
providing a first bus that forms part of WLAN;
providing a second bus that forms part of the WLAN and that is redundant relative to the first bus;
sending communications over the first bus; and
sending communications over the second bus when the first bus fails.

18. The method of claim 17, further comprising sending communications simultaneously over the first and second buses to increase bandwidth.

19. The method of claim 17, further comprising coupling a communication unit comprising a visual display to the WLAN.

20. The method of claim 17, wherein the WLAN is a first WLAN of first military platform, the method further comprising coupling the first WLAN to a second WLAN of a second military platform.
